(19) United States
(12) Patent Application Publication
(10) Pub. No.: US 2010/0074414 A1
(43) Pub. Date: Mar. 25, 2010

(54) Dose measuring method, and phantom and X-ray radiographic device used in dose measuring method

(75) Inventors: Toshizo Katsuda, Okayama (JP); Rumi Gotanda, Okayama (JP)

Correspondence Address: JORDAN AND HAMBURG LLP, 122 EAST 42ND STREET, SUITE 4000, NEW YORK, NY, 10168, US

(73) Assignee: National Unversity Corporation Okayama University, Okayama-shi (JP)

(21) Appl. No.: 12/448,933

(22) PCT Filed: Jan. 16, 2008
(86) PCT No.: PCT/JP2008/050385

§ 371 Date: Jul. 15, 2009

(30) Foreign Application Priority Data
Jan. 16, 2007 (JP) 2007-007379

(51) Int. Cl. G01D 18/00; G01T 1/02

(52) U.S. Cl. 378/207; 250/393

(57) ABSTRACT

The present invention provides a dose measuring method which can more easily measure radiation doses in the whole region to which X-rays are radiated, and a phantom and an X-ray radiographic device which are used in the dose measuring method. In measuring doses by mounting a film-type dosimeter on a phantom, the film-type dosimeter is arranged on the phantom along a plane which includes a center axis on which the rotational center of a rotating X-ray source is positioned or along a plane which traverses the center axis. Particularly, the phantom is divided into at least a first base body and a second base body along a plane along which the film-type dosimeter is arranged, and the film-type dosimeter is sandwiched and fixed by the first base body and the second base body.

### TECHNICAL FIELD

The present invention relates to a dose measuring method in an X-ray radiographic device, and a phantom and an X-ray radiographic device which are used in the dose measuring method, and more particularly to an X-ray radiographic device such as a multi-detector computed tomography or a flat-panel computed tomography which includes an X-ray source rotatable around a body axis of a subject who lies on a bed.

### BACKGROUND OF THE INVENTION

Conventionally, in an examination carried out using a computed tomography (hereinafter simply referred to as “CT”), images are obtained by slicing a human body. In performing the radiography for forming the images, X rays are radiated to a subject while rotating an X-ray source which radiates X rays around a body axis of the subject.

Accordingly, X rays are radiated to the subject from all 360° of an orbit and hence, in this examination, the subject is exposed to X rays for a longer time compared to a general chest X-ray radiography thus giving rise to a possibility that a drawback that the subject receives an excessive doses of X rays arises.

Under such circumstances, to determine whether or not radiation doses of X rays from the X-ray source is at a proper level, the radiation doses are measured in advance.

Particularly, in the examination carried out by the CT, X rays are radiated to a subject from all 360° of an orbit and hence, the measurement of radiation doses in such a case is carried out using a phantom made of an acrylic material and having a columnar shape.

This cylindrical phantom has an insertion hole through which a pencil-shaped dosimeter can be inserted until the dosimeter reaches a predetermined position, and the measurement of the radiation doses of X rays is carried out by inserting the pencil-shaped dosimeter into the insertion hole (see patent document 1, for example).

With the use of such a phantom, it is possible to measure the radiation doses of X rays at the predetermined position. However, what can be measured is the radiation doses in a predetermined region where the dosimeter is arranged and hence, the measurement becomes only a pin-point measurement.

Accordingly, there has been proposed a method of measuring radiation doses in which radiation doses can be measured two-dimensionally using a tabular fluoroglass dosimeter (see patent document 2, for example).

Patent document 1: JP-A-2005-185328
Patent document 2: JP-A-2006-047009

### DISCLOSURE OF THE INVENTION

### Problems that the Invention is to Solve

However, in the measurement of the radiation doses of X rays using the fluoroglass dosimeter, although the radiation doses in the region where the fluoroglass dosimeter is arranged can be accurately measured, when it is necessary to know the radiation doses in a region other than such a region, there arises a drawback that it is necessary to perform the radiation of X rays again by adjusting the arrangement of the fluoroglass dosimeter.

Particularly, when it is necessary to measure the radiation doses in the whole region of the phantom to which the X rays are radiated, it is necessary to repeatedly perform the measurement by sequentially moving the arrangement of the fluoroglass dosimeter in the thickness direction of the fluoroglass dosimeter by an amount corresponding to a thickness of the fluoroglass dosimeter. This measurement requires a considerably long time and hence, such measurement cannot be carried out in an actual measurement.

Under such circumstances, inventors of the present invention have made extensive studies and development for realizing the more convenient measurement of radiation doses in the whole region of the phantom to which X rays are radiated, and have achieved the present invention.

### Means for Solving the Problems

The present invention is directed to a dose measuring method in which doses of X rays in an X-ray radiographic device which performs radiography using X rays by rotating an X-ray source are measured using a film-type dosimeter mounted on a phantom, wherein the film-type dosimeter is arranged on the phantom along a plane which includes a center axis on which the rotational center of the rotating X-ray source is positioned or along a plane which traverses the center axis.

Further, the dose measuring method of the present invention may be also characterized in that the phantom has a circular columnar shape or an elliptical columnar shape, the phantom is divided into at least a first base body and a second base body along a plane on which the film-type dosimeter is arranged, and the film-type dosimeter is sandwiched and fixed by the first base body and the second base body. The phantom may be further characterized by mounting the film-type dosimeter along a peripheral surface of the phantom.

Further, the present invention is directed to a phantom which is used in measuring doses of X rays of an X-ray radiographic device which performs radiography using X rays by rotating an X-ray source, wherein a film-type dosimeter is arranged along a plane which includes a center axis on which the rotational center of the rotating X-ray source is positioned or along a plane which traverses the center axis.

Further, the phantom of the present invention may be also characterized in that the phantom is divided into at least a first base body and a second base body along a plane on which the film-type dosimeter is arranged, and is formed into a circular columnar shape or an elliptical columnar shape by sandwiching and fixing the film-type dosimeter with the first base body and the second base body.

Further, the present invention is directed to an X-ray radiographic device which performs radiography using X rays by rotating an X-ray source around a body axis of a subject who lies on a bed, wherein doses of X rays radiated from the X-ray source is detected and/or calibrated using a phantom on which a film-type dosimeter is arranged along a plane which includes a center axis on which the rotational center of the X-ray source is positioned or along a plane which traverses the center axis.

Further, the X-ray radiographic device of the present invention may be also characterized in that the film-type dosimeter is sandwiched and fixed by the phantom which is divided along the plane which includes the center axis on which the rotational center of the X-ray source is positioned or along the plane which traverses the center axis.

### ADVANTAGE OF THE INVENTION

According to the invention described in claim 1, there is provided a dose measuring method which measures doses of X rays of an X-ray radiographic device which performs radiography using X rays by rotating an X-ray source using a film-type dosimeter which is mounted on a phantom, wherein the film-type dosimeter is arranged on the phantom along a plane which includes a center axis on which the rotational center of the rotating X-ray source is positioned or along a plane which traverses the center axis. Due to such a constitution, a result of the measurement acquired by the film-type dosimeter can be complementarily utilized as a result of measurement at a location which is regarded spatially equal to a position on the film-type dosimeter and hence, doses in the whole region to which X rays are radiated can be measured by performing the measurement one time.

According to the invention described in claim 2, in the dose measuring method described in claim 1, the phantom has a circular columnar shape or an elliptical columnar shape, the phantom is divided into at least a first base body and a second base body along a plane on which the film-type dosimeter is arranged, and the film-type dosimeter is sandwiched and fixed by the first base body and the second base body. Due to such a constitution, it is possible to stably fix the film-type dosimeter.

According to the invention described in claim 3, in the dose measuring method described in claim 1 or 2, the film-type dosimeter is mounted along a peripheral surface of the phantom. Due to such a constitution, it is possible to acquire radiation condition information of X rays radiated to the phantom using the film-type dosimeter mounted on a peripheral surface of the phantom and hence, the dose can be measured more accurately.

According to the invention described in claim 4, there is provided a phantom which is used in measuring doses of X rays of an X-ray radiographic device which performs radiography using X rays by rotating an X-ray source, wherein a film-type dosimeter is arranged along a plane which includes a center axis on which the rotational center of the rotating X-ray source is positioned or along a plane which traverses the center axis. Due to such a constitution, it is possible to provide the phantom which can measure the dose in the whole region to which X rays are radiated by performing the measurement one time.

According to the invention described in claim 5, in the phantom described in claim 4, the phantom is divided into at least a first base body and a second base body along a plane on which the film-type dosimeter is arranged, and is formed into a circular columnar shape or an elliptical columnar shape by sandwiching and fixing the film-type dosimeter with the first base body and the second base body. Due to such a constitution, it is possible to provide the phantom which can surely fix the film-type dosimeter thereto.

According to the invention described in claim 6, there is provided an X-ray radiographic device which performs radiography using X rays by rotating an X-ray source around a body axis of a subject who lies on a bed, wherein doses of X rays radiated from the X-ray source is detected and/or calibrated using a phantom on which a film-type dosimeter is arranged along a plane which includes a center axis on which the rotational center of the X-ray source is positioned or along a plane which traverses the center axis. Due to such a constitution, radiography accuracy can be enhanced. Further, the doses of X rays can be preliminarily measured over the whole region to which X rays are radiated and hence, it is possible to surely prevent a subject from being exposed to an unexpectedly large quantity of X rays.

According to the invention described in claim 7, in the X-ray radiographic device in claim 6, the film-type dosimeter is sandwiched and fixed by the phantom which is divided along the plane which includes the center axis on which the rotational center of the X-ray source is positioned or along the plane which traverses the center axis. Due to such a constitution, the doses of X rays can be accurately measured.

### BRIEF DESCRIPTION OF THE DRAWINGS

FIG. 1 is an overall schematic view of an X-ray radiographic device which is a multi detector computed tomography;

FIG. 2 is an explanatory view of a phantom according to an embodiment of the present invention;

FIG. 3 is an explanatory view of a phantom according to a modification;

FIG. 4 an overall schematic view of an X-ray radiographic device which is a flat panel detector computed tomography;

FIG. 5 is an explanatory view of a phantom according to an embodiment of the present invention; and

FIG. 6 is an explanatory view of a phantom according to a modification.

### DESCRIPTION OF THE REFERENCE NUMERALS AND SIGNS

11, 41: X-ray source
12, 42: circular orbit
12a, 42a: center opening
13, 43: bed
20, 50: film-type dosimeter
30, 60: phantom
30a, 60a: first base body
30b, 60b: second base body
31: fixing jig
31a: projecting lug
32: engaging recessed portion
61: projecting lug
62: engaging hole

### BEST MODE FOR CARRYING OUT THE INVENTION

A measuring method of radiation doses according to the present invention is provided for measuring doses of X rays in an X-ray radiographic device which performs radiography using X rays by rotating an X-ray source such as a multi detector computed tomography or a flat panel computed tomography, wherein the measuring method can measure doses in the whole region to which X rays are radiated by performing the measurement one time.

That is, different from a conventional method in which intensity of X rays is measured using a pencil-type dosimeter, intensity of X rays is measured using a sheet-shaped film-type dosimeter, doses in a predetermined region can be measured by performing the measurement one time.

Particularly, by arranging the film-type dosimeter along a plane which includes a center axis on which the rotational center of the rotating X-ray source is positioned or along a plane which traverses the center axis, a measured result of the dose at a predetermined position measured by the film-type dosimeter can be utilized complementarily as a result of measurement of the dose at a location which is regarded spatially equal to a position on the film-type dosimeter and hence, the dose in the whole region to which X rays are radiated can be measured by performing the measurement one time.

Further, with the use of the film-type dosimeter, the resolution in space can be also remarkably enhanced.

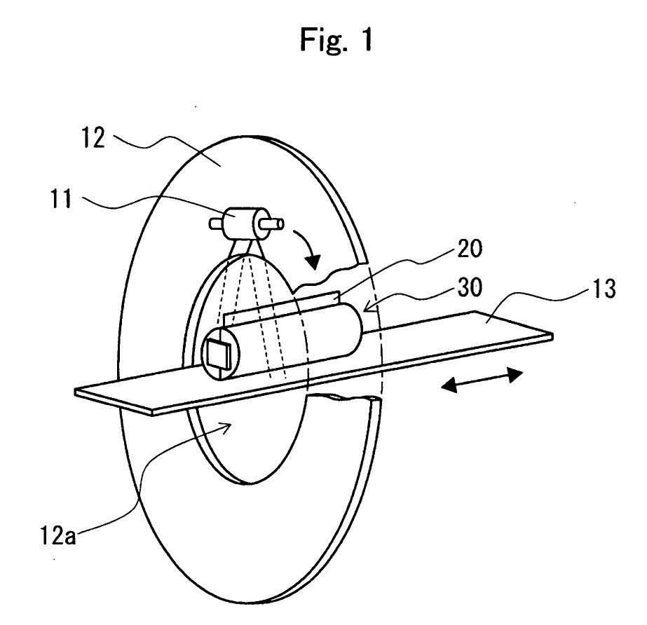

Hereinafter, an embodiment of the present invention is explained in detail in conjunction with drawings. FIG. 1 is an overall schematic view when the X-ray radiographic device is a multi detector computed tomography.

In the multi detector computed tomography, an X-ray source 11 is rotated along a circular orbit 12. A bed 13 is arranged in a center opening 12a formed in the circular orbit (orbit plate) 12 in an insertion state. By advancing or retracting the bed 13 with respect to the center opening 12a such that the bed 13 is inserted into the center opening 12a or removed from the center opening 12a, it is possible to acquire a cross-sectional image of a subject by placing the subject who lies on the bed 13 in the center opening 12a.

In measuring the doses of X rays of the X-ray radiographic device, a phantom 30 which mounts a film-type dosimeter 20 thereon is arranged on the bed 13, and X rays are radiated to the phantom 30 under the same X-ray radiation condition as radiography of the whole body of the subject.

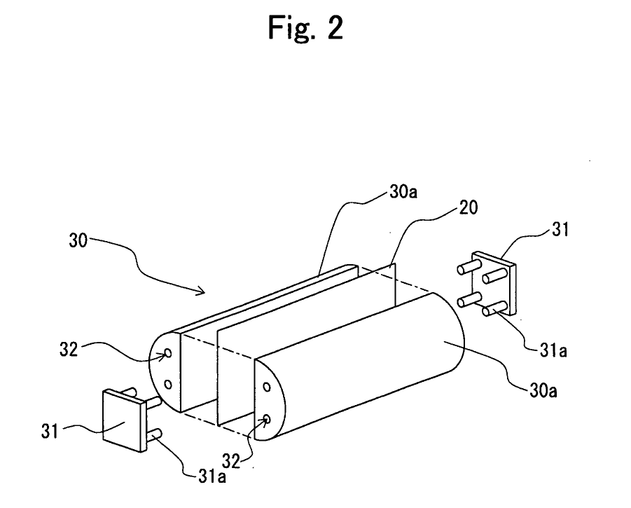

The film-type dosimeter 20 is formed of a radio chromic film, and has a size which allows the film-type dosimeter 20 to measure the dose within a predetermined dose measurable range. As shown in FIG. 2, in this embodiment, the film-shaped dosimeter 20 has a rectangular shape. However, the shape of the film-type dosimeter is not limited to the rectangular shape, and the film-type dosimeter 20 may have a suitable shape. Further, in this embodiment, the film-type dosimeter 20 is constituted of one sheet of film-type dosimeter 20 which covers a measurable range of radiation doses. However, the dose measurable range may be covered with plural sheets of film-type dosimeter depending on a case.

The phantom 30, as shown in FIG. 2, is constituted of a first base body 30a and a second base body 30b which are semicircular columnar bodies obtained by dividing a circular columnar body in two in the center axis direction. The first base body 30a and the second base body 30b respectively have a plane which includes a center axis of the semicircular columnar body, and the first base body 30a and the second base body 30b sandwich the film-type dosimeter 20 between the respective planes thereof.

The first base body 30a and the second base body 30b may preferably be formed using a material having property close to an attenuation ratio of X rays in a human body. That is, in the same manner as a conventional phantom, the first base body 30a and the second base body 30b may be formed using an acryl, soft acryl or the like as a material. Alternatively, the first base body 30a and the second base body 30b may have the hollow structure in which water is filled.

A size of the first base body 30a and a size of the second base body 30b may be properly set depending on a size of a part to be examined of a subject. In this embodiment, assuming that the part to be examined of the subject is a trunk body of a general-structured adult, the first base body 30a and the second base body 30b are formed by dividing a circular cylindrical body having a diameter of approximately 30 cm in two. A length of the first base body 30a and the second base body 30b is set to 30 cm or more. Here, for example, when the subject is a child or an immature infant or when a part of the subject such as an arm or a head is to be diagnosed, it is desirable to use smaller-sized first and second base bodies 30a, 30b. That is, the first base body 30a and the second base body 30b may be formed by dividing a circular cylindrical body having a diameter of approximately 6 to 30 cm in two.

In FIG. 2, numeral 31 indicates fixing jigs which are respectively mounted on both end portions of the first base body 30a and the second base body 30b so as to integrally connect the first base body 30a and the second base body 30b. The fixing jigs include projecting lugs 31a which are inserted into engaging recessed portions 32 respectively formed in both end surfaces of the first base body 30a and the second base body 30b at predetermined positions. By inserting the projecting lugs 31a into the engaging recessed portions 32, the first base body 30a and the second base body 30b are connected to each other by way of the fixing jigs 31. Fixing jigs which integrally connect the first base body 30a and the second base body 30b are not limited to parts having the above-mentioned configuration, and the first base body 30a and the second base body 30b may be integrally connected to each other using a proper fixing jig.

The film-type dosimeter 20 which is sandwiched by the first base body 30a and the second base body 30b may, provided that the film-type dosimeter 20 per se can prevent deflection thereof due to sufficient resiliency thereof, have a size which allows the film-type dosimeter 20 to project from the phantom 30 as shown in FIG. 1.

The phantom 30 on which the film-type dosimeter 20 is mounted in this manner is arranged at a predetermined position of the bed 13 as shown in FIG. 1, and X rays are radiated to the phantom 30. Here, the phantom 30 on the bed 13 is arranged along the advancing and retracting direction of the bed 13. The film-type dosimeter 20 is positioned on a vertical plane including a center axis of the circular orbit 12, that is, a center axis on which the rotational center of the rotating X-ray source 11 is positioned. Further, the center axis on which the rotational center of the X-ray source 11 is positioned is positioned on the film-type dosimeter 20.

Here, provided that the center axis on which the rotational center of the X-ray source 11 is positioned can be positioned on the film-type dosimeter 20, it is not always necessary to position the film-type dosimeter 20 on the vertical plane including the center axis on which the rotational center of the X-ray source 11 is positioned. In an actual operation, however, it is difficult to position the center axis on which the rotational center of the X-ray source 11 is positioned on the film-type dosimeter 20 without arranging the film-type dosimeter 20 on the vertical plane including the center axis on which the rotational center of the X-ray source 11 is positioned. Accordingly, the film-type dosimeter 20 is arranged on the vertical plane including the center axis on which the rotational center of the X-ray source 11 is positioned.

Along with the radiation of X rays to the film-type dosimeter 20, the distribution of variable density corresponding to the distribution of doses is generated in the film-type dosimeter 20 so that information on the distribution of doses of X rays can be acquired from this distribution of variable density. Particularly, since information on distribution of doses appears in a form of variable density, it is possible to visually confirm information on distribution of doses.

Further, this information on distribution of doses is fetched into an electronic computer such as a personal computer using a scanner device or the like, the digitization corresponding to density is carried out, and the distribution information is rotated around the center axis of the film-type dosimeter 20 thus acquiring three-dimensional dose distribution data. Here, the digitization corresponding to density implies, for example, that the density of film-type dosimeter 20 is digitized in accordance with preliminarily set 256 scales or 1024 scales or the like. The three-dimensional distribution data on radiation doses is generated based on such digitized distribution information.

Accordingly, provided that the film-type dosimeter 20 which is sandwiched by the first base body 30a and the second base body 30b has a size of region which is at least equal to one half of the plane formed on the first base body 30a and the second base body 30b including the center axis of the circular orbit 12, by rotating the distribution information on radiation doses around the center axis on the film-type dosimeter 20 by 360°, it is possible to generate three-dimensional distribution data of radiation doses as three-dimensional distribution information.

It is possible to confirm that the radiation doses of X rays from the X-ray source 11 is appropriate based on the distribution data obtained in the above-mentioned manner and hence, it is possible to provide an X-ray radiographic device which can completely prevent unexpected X-ray exposure. In performing the measurement of doses aiming at the calibration of X-ray source 11, a dosimeter which can detect magnitude of doses of X rays is mounted on at least one portion of the phantom 30, and radiation doses from the X-ray source 11 may be determined based on a result of detection by the dosimeter and dose distribution information from the film-type dosimeter 20.

In this embodiment, the phantom 30 which is constituted of the first base body 30a and the second base body 30b is formed of a circular columnar body. However, the phantom 30 is not limited to the circular columnar body, and may be formed of an elliptical columnar body. Also when the phantom 30 is formed of the elliptical columnar shape, the phantom is constituted of a first base body and a second base body which are formed by dividing the elliptical columnar body by a plane which includes a center axis, and a film-type dosimeter is sandwiched between dividing surfaces of the first base body and the second base body.

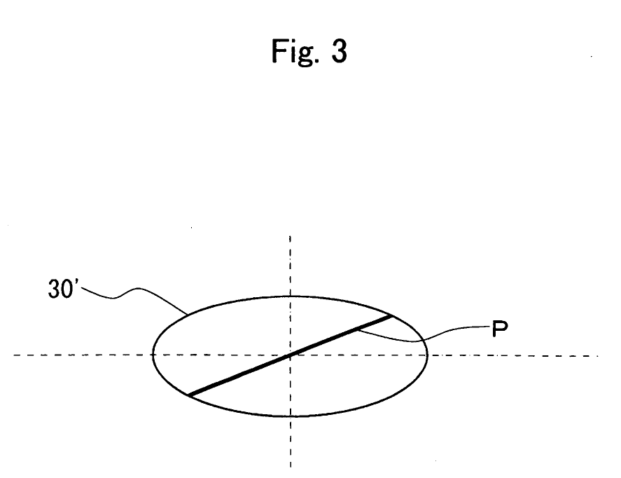

A size of dividing face, as schematically shown in FIG. 3, differs depending on a mode in which a dividing face P is formed with respect to a phantom 30′ formed of an elliptical columnar body, and the size of the dividing face may be suitably set corresponding to necessity. Here, when the phantom 30′ formed of the elliptical circular body is used, by preliminarily adjusting a shape of the phantom 30′, a center axis of the phantom 30′ formed of the elliptical columnar body can be easily aligned with a center axis of a circular orbit 12 and hence, a proper dividing face P can be obtained.

Further, in this embodiment, the phantom 30 is constituted of the first base body 30a and the second base body 30b. When the first base body 30a and the second base body 30b are formed using an acrylic material, respective weights of the first base body 30a and the second base body 30b easily become relatively large and hence, there may be a case that a physically weak person cannot handle the first base body 30a and the second base body 30b. In such a case, the first base body 30a and the second base body 30b may be further divided. For example, the first base body 30a and the second base body 30b having a semicircular columnar shape may be respectively divided in two thus forming 4 pieces of quarter columnar bodies.

Further, when the first base body 30a and the second base body 30b respectively adopts such dividable structure, a film-type dosimeter may be further sandwiched between the respective dividing-face portions and hence, the detection accuracy of dose distribution information can be further enhanced.

Alternatively, on a peripheral surface of the phantom 30 which is formed by connecting the first base body 30a and the second base body 30b, a film-type dosimeter may be mounted using an appropriate adhesive tape or the like. When the film-type dosimeter is mounted on the peripheral surface of the phantom 30 in this manner, a rotational angle of the X-ray source 11 which rotates along the circular orbit 12 can be detected. For example, it is possible to detect the radiation condition information on X rays such as information that the X-ray source 11 is not rotated by one turn along the circular orbit 12 or the information that the X-ray source 11 rotates by one turn or more along the circular orbit 12 thus acquiring correction information for enhancing detection accuracy of dose distribution.

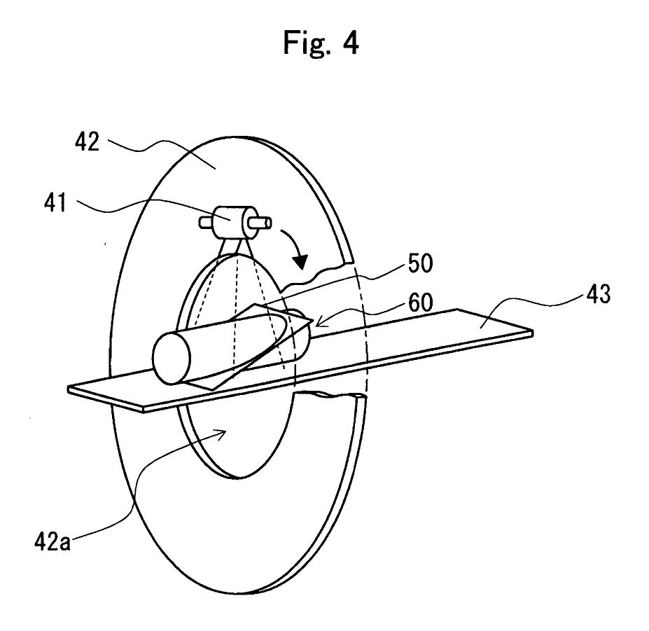

Next, the explanation is made with respect to a case in which the X-ray radiographic device is a flat-panel computed tomography as shown in FIG. 4.

Also in the flat-panel computed tomography, an X-ray source 41 is rotated along a circular orbit 42. A bed 43 is arranged in a center opening 42a formed in the circular orbit 42 in an insertion state. In the flat-panel computed tomography, X rays are radiated from the X-ray source 41 in a largely dispersed manner and hence, it is unnecessary to advance or retract a bed 43 during radiography and hence, the bed 43 is advanced or retracted only for adjusting a radiography position.

In measuring the doses of the X-ray radiographic device, a phantom 60 which mounts a film-type dosimeter 50 thereon is arranged on the bed 43, and X rays are radiated to the phantom 60 under the same X-ray radiation condition as radiography of a subject.

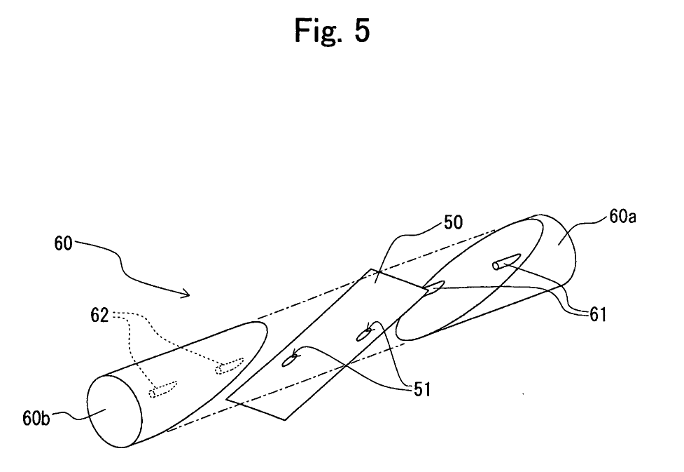

The film-type dosimeter 50 is formed of a radio chromic film, and has a size which allows the film-type dosimeter 50 to measure the dose within a predetermined dose measurable range. As shown in FIG. 5, also in this embodiment, the film-shaped dosimeter 50 has a rectangular shape. However, the shape of the film-type dosimeter 50 is not limited to the rectangular shape, and the film-type dosimeter 50 may have a suitable shape.

The phantom 60, as shown in FIG. 5, is constituted of a first base body 60a and a second base body 60b which are obtained by dividing a circular columnar body in two. Particularly, the first base body 60a and the second base body 60b are formed into shapes obtained by dividing the circular columnar body with a plane which traverses a center axis on which the rotational center of the rotating X-ray source 41 is positioned, and a predetermined inclined plane is formed on the first base body 60a and the second base body 60b respectively. The film-type dosimeter 50 is arranged between inclined planes, and is sandwiched between the first base body 60a and the second base body 60b. The phantom 60 is not limited to a circular columnar body, and may be formed of an elliptical columnar body.

The first base body 60a and the second base body 60b may preferably be formed using a material having property close to an attenuation ratio of X rays in a human body. That is, in the same manner as a conventional phantom, the first base body 60a and the second base body 60b may be formed using an acryl, soft acryl or the like as a material. Alternatively, the first base body 60a and the second base body 60b may have the hollow structure to allow filling of water into the first base body 60a and the second base body 60b.

With respect to a size of the first base body 60a and a size of the second base 60b, also in this embodiment, assuming that the part to be examined of the subject is a trunk body of a general-structured adult, the first base body 60a and the second base body 60b are formed by dividing a circular cylindrical body having a diameter of approximately 30 cm in two. Here, for example, when the subject is a child or an immature infant or when a part of the subject such as an armor a head is diagnosed, it is desirable to use smaller-sized first and second base bodies 30a, 30b. That is, it is desirable that the first base body 30a and the second base body 30b are formed by dividing a circular cylindrical body having a diameter of approximately 6 to 30 cm in two, and a center axis of the circular columnar body which is formed by connecting the first base body 60a and the second base body 60b is aligned with the rotational center of the rotating X-ray source 41.

A length of the first base body 60a and the second base body 60b is set to 30 cm or more so that the phantom can cover a general radiography region in the flat-panel computed tomography. That is, the inclined planes which are respectively formed on the first base body 60a and the second base body 60b are configured to include the general radiography region in the flat-panel computed tomography. Accordingly, the X-ray radiographic device can measure doses in a necessary and sufficient region by arranging the film-type dosimeter 50 along these inclined planes.

Here, in this embodiment, projecting lugs 61 are mounted on the inclined plane of the first base body 60a in a projecting manner from the inclined plane at the predetermined position, while fitting holes 62 into which the projecting lugs 61 are fitted are formed in the inclined plane of the second base body 60b at predetermined positions where the fitting holes 62 face the projecting lugs 61 in an opposed manner. By fitting the projecting lugs 61 into the fitting holes 62, the first base body 60a and the second base body 60b can be integrally connected with each other.

The projecting lugs 61 may be formed of a circular columnar connecting pin, and fitting holes into which the projecting lugs 61 are inserted may be formed in the inclined plane of the first base body 60a at predetermined positions, and the first base body 60a and the second base body 60b may be integrally connected to each other by way of the projecting lugs 61. Although the projecting lugs 61 are formed into a circular columnar shape in this embodiment, the projecting lugs 61 are not limited to such a circular columnar shape and may have a suitable shape.

Alternatively, in place of connecting the first base body 60a and the second base body 60b by fitting the projecting lugs 61 into the fitting holes 62, the first base body 60a and the second base body 60b may be connected to each other as follows. Through holes are respectively formed on the first base body 60a and the second base body 60b in a penetrating manner, a connecting bolt which penetrates the first base body 60a and the second base body 60b in series is inserted into the through holes, end portions of the connecting bolt are respectively projected from the first base body 60a and the second base body 60b, and fixing nuts are mounted on the end portions of the connecting bolt so that the first base body 60a and the second base body 60b are integrally connected to each other by way of the connecting bolt. Here, to prevent the scattering of X rays, it is desirable to form the connecting bolt using an acrylic material or a soft acrylic material.

Through holes 51 through which the projecting lugs 61 are inserted are formed at predetermined positions in the film-type dosimeter 50 sandwiched by the first base body 60a and the second base body 60b. In forming a plurality of through holes 51, the through holes 51 are arranged while avoiding positions which become symmetrical with a rotational center position of the X-ray source 41 on the film-type dosimeter 50 sandwiched therebetween, and the projecting lugs 61 and the fitting holes 62 are formed in alignment with the positions of the through holes 51. Due to such a constitution, a result of measurement of a region where doses cannot be measured due to the formation of the through holes 51 can be complemented by a result of measurement of other point which is regarded spatially equal to the result of measurement of the non-measurable region thus preventing the generation of non-measured regions due to the formation of through holes 51.

Further, the film-type dosimeter 50 may, provided that the film-type dosimeter 50 per se can prevent deflection thereof due to resiliency thereof, have a size which allows the film-type dosimeter 50 to project from the phantom 60 as shown in FIG. 4 so that the film-type dosimeter 50 can measure doses of X rays without being restricted by the size of the phantom 60.

The phantom 60 on which the film-type dosimeter 50 is mounted in this manner is arranged at a predetermined position of the bed 43, and X rays are radiated to the phantom 60. Here, the phantom 60 on the bed 43 is arranged such that a center axis of the phantom 60 having a circular columnar shape is aligned with a center axis of a circular orbit 42, that is, a center axis on which the rotational center of the rotating X-ray source 41 is positioned, and X rays are radiated to the phantom 60.

Along with the radiation of X rays to the film-type dosimeter 50, the distribution of variable density corresponding to the distribution of doses is generated in the film-type dosimeter 50 so that information on the distribution of doses of X rays can be acquired from this distribution of variable density. Particularly, since information on distribution of doses appear in a form of variable density, it is possible to visually confirm information on distribution of doses.

Further, this information on distribution of doses is fetched into an electronic computer such as a personal computer using a scanner device or the like, the digitization corresponding to density is carried out. Further, using a measured value by the film-type dosimeter 50 as a result of measurement of dose at a location which is regarded spatially equal to a position on the film-type dosimeter 50, the doses in the whole region to which X rays are radiated are measured by performing the measurement one time.

In the flat-panel computed tomography, the film-type dosimeter 50 is arranged in a state that the film-type dosimeter 50 traverses the center axis of the rotating X-ray source 41 and hence, the location which is regarded spatially equal to the position on the film-type dosimeter 50 is a location parallel to the center axis.

That is, by moving distribution information of doses obtained by the film-type dosimeter 50 parallel to the center axis, it is possible to obtain three-dimensional distribution data of doses.

It is possible to confirm that the radiation doses of X rays from the X-ray source 11 are appropriate based on the dose distribution data obtained in the above-mentioned manner and hence, it is possible to provide an X-ray radiographic device which can completely prevent unexpected X-ray exposure.

Alternatively, on a peripheral surface of the phantom 60 which is formed by connecting the first base body 60a and the second base body 60b, a film-type dosimeter may be mounted using an appropriate adhesive tape or the like. When the film-type dosimeter is mounted on the peripheral surface of the phantom 60 in this manner, a rotational angle of the X-ray source 41 which rotates along the circular orbit 42 can be detected. For example, it is possible to detect the radiation condition information of X rays such as information that the X-ray source 41 is not rotated by one turn along the circular orbit 42 or the information that the X-ray source 41 rotates by one turn or more along the circular orbit 42 thus acquiring correction information for enhancing dose measurement accuracy.

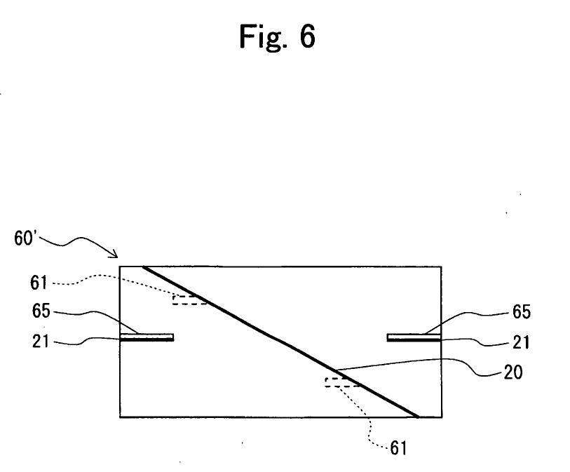

With respect to the phantom 60 of this embodiment, regions where doses cannot be measured are formed on both end portions of the phantom 60. Accordingly, as shown in FIG. 6, the phantom 60′ may be configured such that slits 65 which allow the insertion of a film-type dosimeter are formed in both ends of the phantom 60′, and an auxiliary film-type dosimeter 21 which is formed of a film-type dosimeter having a predetermined shape is arranged in the slits 65, and the auxiliary film-type dosimeter 21 measures doses in an auxiliary manner. Here, one surface of the slit 65 is set as a plane which includes the center axis of the phantom 60′ having a circular columnar shape, and the auxiliary film-type dosimeter 21 is arranged on the plane of the slit 65.

In this manner, by mounting the film-type dosimeter 50 on the phantom 60 in a state that the film-type dosimeter 50 traverses the center axis on which the rotational center of the rotating X-ray source 41 is positioned, it is possible to realize the dose measurement with high accuracy and high resolution for the first time in the flat-panel computed tomography.

In this embodiment, the explanation has been made with respect to the case in which, in the flat-panel computed tomography, the film-type dosimeter 50 is mounted on the phantom 60 in a state that the film-type dosimeter 50 traverses the center axis on which the rotational center of the rotating X-ray source 41 is positioned. However, as shown in FIG. 1, this embodiment may also use the phantom which mounts the film-type dosimeter thereon in a state that the film-type dosimeter is positioned on the vertical plane including the center axis on which the rotational center of the rotating X-ray source is positioned. In the same manner, this embodiment may also use a phantom which mounts a film-type dosimeter thereon in a state that the film-type dosimeter traverses a center axis on which the rotational center of a rotating X-ray source is positioned in a multi detector computed tomography.

Further, in this embodiment, basically, the film-type dosimeter is sandwiched by dividing surfaces of the phantom which are formed by division. However, the phantom may be used in a form that a slit which allows the insertion of the film-type dosimeter therein may be formed in the phantom at a predetermined position, and the film-type dosimeter is inserted into the slit. However, the phantom is relatively heavy and hence, when a large slit is formed in the phantom, there exists a possibility that the phantom is broken from a slit portion. Further, the smaller the phantom, the more handling property including carrying can be enhanced. Accordingly, the phantom is configured to be dividable in at least two by dividing along surfaces.

### INDUSTRIAL APPLICABILITY

In an X-ray radiographic device such as a multi-detector computed tomography or a flat-panel computed tomography which can measure doses in a pin-point manner conventionally, due to the provision of the present invention, the distribution of doses can be detected with high resolution spatially thus eliminating possibility that a subject receives an unexpected X-ray exposure in the X-ray radiographic device.

1. A dose measuring method, comprising measuring doses of X rays in an X-ray radiographic device which performs radiography using X rays by rotating an X-ray source using a film dosimeter mounted on a phantom, wherein
the film dosimeter is arranged on the phantom along a plane which includes a center axis on which a rotational center of the rotating X-ray source is positioned or along a plane which traverses the center axis.

2. A dose measuring method according to claim 1, wherein the phantom has a circular columnar shape or an elliptical columnar shape, the phantom is divided into at least a first base body and a second base body along a plane on which the film dosimeter is arranged, and the film dosimeter is sandwiched and fixed by the first base body and the second base body.

3. A dose measuring method according to claim 1 or 2, wherein the film dosimeter is mounted along a peripheral surface of the phantom.

4. A phantom and a film dosimeter arranged thereon for measuring doses of X rays of an X-ray radiographic device which performs radiography using X rays by rotating an X-ray source, the film dosimeter being arranged along a plane which includes a center axis on which a rotational center of the rotating X-ray source is positioned or along a plane which traverses the center axis.

5. A phantom and film dosimeter according to claim 4, wherein the phantom has a circular columnar shape or an elliptical columnar shape and is divided into at least a first base body and a second base body along a plane on which the film dosimeter is arranged, the film dosimeter being sandwiched and fixed by the first base body and the second base body.

6. An X-ray radiographic device which is configured to perform radiography using X rays by rotating an X-ray source around a body axis of a subject who lies on a bed, and a phantom on which a film dosimeter is arranged for detecting or calibrating doses of X rays radiated from the X-ray source, the film dosimeter being arranged along a plane which includes a center axis on which a rotational center of the X-ray source is positioned or along a plane which traverses the center axis.

7. An X-ray radiographic device according to claim 6, wherein the film dosimeter is sandwiched and fixed by the phantom which is divided along the plane which includes the center axis on which the rotational center of the X-ray source is positioned or along the plane which traverses the center axis.
